(19) United States
(12) Patent Application Publication
(10) Pub. No.: US 2022/0076189 A1
(43) Pub. Date: Mar. 10, 2022

(54) AN INFORMATION EXCHANGE AND SYNCHRONIZATION METHOD AND APPARATUS

(71) Applicant: Beijing DiDi Infinity Technology and Development Co., Ltd., Beijing (CN)

(72) Inventor: Tianyi LENG, BEIJING (CN)

(21) Appl. No.: 17/423,563

(22) PCT Filed: Mar. 12, 2019
(86) PCT No.: PCT/CN2019/077816

§ 371 Date: Jul. 16, 2021

(30) Foreign Application Priority Data
Jan. 17, 2019 (CN) 201910044109.8

(51) Int. Cl. G06Q 10/06; G06Q 10/02; G06Q 50/30

(52) U.S. Cl. CPC G06Q 10/063114; G06Q 50/30; G06Q 10/02

(57) ABSTRACT

Methods, systems, and apparatus, including computer programs encoded on computer storage media, for exchange and synchronization of status information of a vehicle. One of the methods includes obtaining, by a terminal, status information of the vehicle from equipment on the vehicle and connected to the terminal, sending, by the terminal, the status information to a server, and receiving, by the terminal and from the server, an updated status identifier associated with the terminal, wherein the updated status identifier is determined based on the status information.

### CROSS REFERENCE TO RELATED APPLICATION

This application claims priority to and benefits of Chinese Patent Application No. CN201910044109.8, filed with the State Intellectual Property Office (SIPO) of the People's Republic of China on Jan. 17, 2019, and entitled “An Information Exchange and Synchronization Method and Apparatus Implemented at a Service-providing Terminal.” The entirety of the aforementioned application is incorporated herein by reference.

### TECHNICAL FIELD

The disclosure relates generally to exchange and synchronization of status information of a vehicle.

### BACKGROUND

A ride-hailing platform can automatically connect users requesting transportation services (“service requesters”) with users providing transportation services (“service providers”). Each service requester or passenger pays for using the transportation services, while each service provider or vehicle driver receives compensation for providing the transportation services. A service provider may use a mobile terminal to communicate with the ride-hailing platform and one or more terminals associated with one or more service requesters. A service provider may need to communicate status information associated with the vehicle to the ride-hailing platform. If the terminal is not capable of automatically recording the status of the vehicle while the vehicle is operating, the service provider may need to manually record and update the status of the vehicle. In case the service provider neglects to record or update the current status of the vehicle to the terminal, status information recorded by the mobile terminal may be inconsistent with the actual status of the vehicle.

Inconsistency between vehicle status information recorded by the mobile terminal and the actual vehicle status may result in erroneously execution of operations that are based on status of the vehicle. For example, in a scenario of a ride-hailing service, if the mobile terminal does not have correct vehicle status information, it may not be able to correctly perform operations such as dispatching and returning a vehicle, thereby impacting a driver's order acceptance rate, a driver's delay in accepting orders online, and a waiting time for a passenger.

### SUMMARY

Various embodiments of the present disclosure can include systems, methods, and non-transitory computer readable media for exchange and synchronization of status information of a vehicle.

According to one aspect, a method for controlling a terminal based on status information of a vehicle comprises obtaining, by the terminal, status information of the vehicle from equipment on the vehicle and connected to the terminal, sending, by the terminal, the status information to a server, and receiving, by the terminal and from the server, an updated status identifier associated with the terminal, wherein the updated status identifier is determined based on the status information.

In some embodiments, the method further comprises executing, by the terminal, an operation associated with the vehicle based on the received updated status identifier.

In some embodiments, the updated status identifier comprises a request-accepting status identifier indicating that a new service request received by the terminal can be accepted, a request-rejecting status identifier indicating that a new service request received by the terminal must be rejected, or a payment-processing status identifier indicating that a payment for a service order fulfilled by the terminal is to be processed.

In some embodiments, the executing an operation associated with the vehicle comprises determining that the updated status identifier is a request-accepting status identifier and accepting a service request associated with the vehicle received by the terminal.

In some embodiments, the executing an operation associated with the vehicle comprises determining that the updated status identifier is a request-rejecting status identifier and rejecting a service request associated with the vehicle received by the terminal.

In some embodiments, the executing an operation associated with the vehicle comprises determining that the updated status identifier is a payment-processing status identifier, obtaining a fare for the service order recorded by the equipment, determining a target fare based on the fare recorded by the equipment, and sending the target fare to a terminal associated with a service requester.

In some embodiments, the obtaining status information of the vehicle comprises determining, based on an identifier associated with the vehicle, that the vehicle is installed with the equipment, obtaining an identifier associated with the equipment, establishing a network connection with the equipment based at least in part on the obtained identifier associated with the equipment, and obtaining the status information from the equipment via the network connection.

In some embodiments, the terminal has access to a data store associated with the equipment via a network connection. The data store is configured to permit data reading but block data writing by the terminal.

According to another aspect, a system associated with a terminal controlled based on status information of a vehicle comprises a processor and a non-transitory computer-readable storage medium storing instructions executable by the processor to cause the system to perform operations comprising obtaining status information of the vehicle from equipment on the vehicle and connected to the terminal, sending the status information to a server, and receiving, from the server, an updated status identifier associated with the terminal, wherein the updated status identifier is determined based on the status information.

According to another aspect, a non-transitory computer-readable storage medium associated with a terminal controlled based on status information of a vehicle is configured with instructions executable by one or more processors to cause the one or more processors to perform operations comprising obtaining status information of the vehicle from equipment on the vehicle and connected to the terminal, sending the status information to a server, and receiving, from the server, an updated status identifier associated with the terminal, wherein the updated status identifier is determined based on the status information.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

Preferred and non-limiting embodiments of the invention may be more readily understood by referring to the accompanying drawings in which:

FIG. 1 illustrates an example network environment associated with an information exchange and synchronization system.

FIG. 2 illustrates an example electronic device.

FIG. 3 illustrates an example method for controlling a terminal based on status information of a vehicle.

FIG. 4 illustrates an example interface associated with an example taximeter.

FIG. 5 illustrates an example method for obtaining status information from equipment on a vehicle.

FIG. 6A illustrates an example interface for establishing a connection between a terminal and equipment on a vehicle using a Bluetooth box.

FIG. 6B illustrates an example interface for selecting a vehicle.

FIG. 6C illustrates an example interface for selecting a vehicle.

FIG. 7 illustrates an example method for updating a status identifier associated with a terminal based on status information of a vehicle.

FIG. 8 illustrates an example method for synchronizing status information of a vehicle to a server.

FIG. 9 illustrates an example method for controlling a terminal based on status information of a vehicle.

FIG. 10 illustrates a structural diagram of an information exchange and synchronization apparatus.

FIG. 11 illustrates a structural diagram of an information exchange and synchronization apparatus.

FIG. 12 illustrates a structural diagram of an information exchange and synchronization apparatus.

### DETAILED DESCRIPTION OF THE EMBODIMENTS

Specific, non-limiting embodiments of the present invention will now be described with reference to the drawings. Particular features and aspects of any embodiment disclosed herein may be used and/or combined with particular features and aspects of any other embodiment disclosed herein. It should also be understood that such embodiments are by way of example and are merely illustrative of a small number of embodiments within the scope of the present invention. Various changes and modifications obvious to one skilled in the art to which the present invention pertains are deemed to be within the spirit, scope and contemplation of the present invention as further defined in the appended claims.

In some embodiments, equipment on a vehicle may generate status information of the vehicle based on operations by a user on the equipment and send the status information to a terminal (e.g., one associated with a transportation service provider) corresponding to the vehicle for synchronization to a server associated with an online platform (e.g., a ride-hailing service platform). The server may determine whether to update a status identifier associated with the terminal based on the status information and generate and send any necessary updated status identifier to the terminal. The terminal may then perform one or more operations associated with the transportation service based on the updated status identifier.

Particular embodiments may allow automatic recordation and synchronization of a vehicle's status information and automatic control of a ride-hailing service based on such synchronized status information. Particular embodiments thereby may save a service provider's effort in manually inputting information and controlling various aspects of the transportation service and may prevent error caused by personal negligence of the service provider. For example, particular embodiments may improve a service provider's order acceptance rate, reduce a service provider's delay in accepting orders online, or reduce a passenger's waiting time after placing an order for transportation services. Furthermore, by automatically synchronizing vehicle status information with an online platform, particular embodiments may improve the overall efficiency of services associated with the online platform. For example, particular embodiments may improve an efficiency of order distribution by the platform or reduce an error rate of order distribution.

Particular embodiments are described in the example scenario of ride-hailing services for illustration purposes. The terms “passenger” and “service requester” may be used interchangeably to refer to individuals, entities, or tools that request or order services. The terms “driver”, “service provider” and “user” may be used interchangeably to refer to individuals, entities, or tools that can provide services. Particular embodiments may be implemented in a plurality of other scenarios corresponding to other types of transportation. They may be implemented in other transportation environments such as land, sea, aviation, or any combination thereof. Vehicles may include taxis, private cars, cars for ride sharing services, buses, trains, bullet trains, high-speed railways, metros, ships, aircraft, spaceships, hot balloons, or self-driving cars, or any combination thereof. Particular embodiments may also be implemented in any suitable service systems suitable to use status synchronization including, for example, a system for sending and/or receiving mail delivery. The application of the apparatus or method of this application may include web pages, plug-ins of browsers, customized systems, internal analysis systems, artificial intelligence robots, other suitable applications, or any combination thereof.

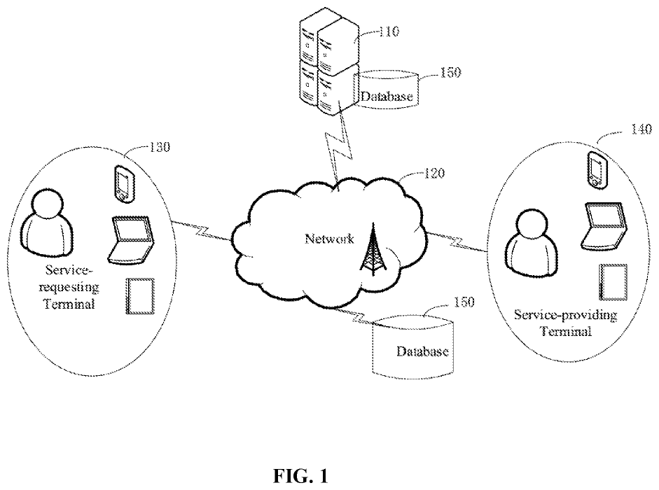

FIG. 1 illustrates an example network environment associated with an information exchange and synchronization system. The information exchange and synchronization system may be used for transportation services including, for example, taxi service, driving service, fast-ride service, ride-sharing service, bus service, driver rental, shuttle service, other suitable transportation services, any combination thereof, or online platforms offers one or more of the transportation services. The information exchange and synchronization system (e.g., one for service-provider side) may include one or more of servers 110, networks 120, service-requesting terminals 130, service-providing terminals 140 and databases 150. The server 110 may include one or more processors that execute instructions.

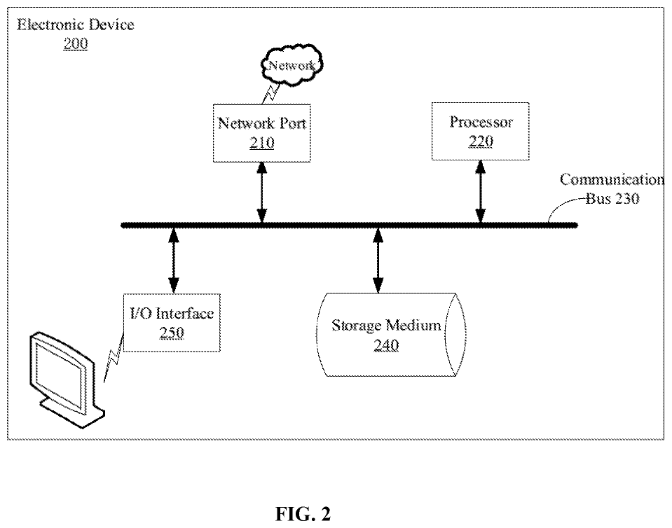

In some embodiments, the server 110 may be a single server or a server group. The server group may be centralized or distributed (e.g., the server 110 may be a distributed system). In some embodiments, the server 110 may be local or remote relative to a terminal. For example, the server 110 may access information and/or data stored in the service-requesting terminal 130, the service-providing terminal 140, the database 150, or any combination thereof via a network 120. In some embodiments, the server 110 may be implemented on a cloud platform. As an example, a cloud platform may comprise a private cloud, a public cloud, a mixed cloud, a community cloud, a distributed cloud, an inter-cloud, and multi-clouds, or any combination thereof. In some embodiments, the server 110 may be implemented on an electronic device 200 comprising one or more components shown in FIG. 2.

In some embodiments, the server 110 may comprise a processor 220. The processor 220 may process information and/or data related to a service request, so as to execute one or more functions described herein. In some embodiments, the processor may comprise one or more processing cores (e.g., a single-core processor (S) or a multi-core processor (S)). As an example, the processor can comprise Central Processing Unit (CPU), Application Specific Integrated Circuit (ASIC), Application Specific Instruction-set Processor (ASIP), Graphics Processing Unit (GPU), Physics Processing Unit (PPU), Digital Signal Processor (DSP), Field Programmable Gate Array (FPGA), Programmable Logic Device (PLD), controller, microcontroller unit, Reduced Instruction Set Computing (RISC), micro-processor, another suitable component, or any combination thereof.

The network 120 may be used for information or data exchange. In some embodiments, one or more components (e.g., server 110, service-requesting terminal 130, service-providing terminal 140, database 150) of the information exchange and synchronization system may send information or data to other components. For example, the server 110 may obtain service requests from the service-requesting terminal 130 via the network 120.

In some embodiments, one or more components of the information exchange and synchronization system (e.g., server 110, service-requesting terminal 130, service-providing terminal 140) may have access to the database 150. In some embodiments, when certain conditions are met, one or more components of the information exchange and synchronization system may read or modify information associated with the service-requesting terminal 130, the service-providing terminal 140, public information, or any combination thereof. As an example and not by way of limitation, the server 110 may be enabled to read or modify the information of one or more users after receiving a service request. As another example and not by way of limitation, the service-providing terminal 140 can access information associated with a service requester when receiving a service request from the service-requesting terminal 130, but the service-providing terminal 140 may not be able to modify the information associated with the service-requesting terminal 130.

In some embodiments, information exchange among one or more components of the information exchange and synchronization system can be achieved by requesting service. An object of the service request may be vehicle status information of a vehicle in synchronization.

FIG. 2 illustrates an example electronic device 200. The electronic device 200 may be used to implement the server 110, service-requesting terminal 130, or the service-providing terminal 140 as illustrated in FIG. 1. The electronic device 200 may comprise a processor 220 that may be used to execute functions disclosed herein. The electronic device 200 may be a computing device, such as a general computer or a computer with a special use, which may be used to implement the methods disclosed herein. Although FIG. 2 illustrates one electronic device 200, functions set forth herein may be implemented in a distributed manner on a plurality of similar platforms to distribute or balance processing load.

In some embodiments, the electronic device 200 may comprise a network port 210 connected to a network, one or more processors 220 for executing program instructions, a communication bus 230, and storage media 240. The storage media 240 may comprise a magnetic disk, ROM, RAM, another suitable storage medium, or any combination thereof. In some embodiments, a computer platform may further comprise program instructions stored in ROM, RAM, other types of non-transitory storage media, or any combination thereof. Methods according to particular embodiments disclosed herein may be implemented according to the program instructions. The electronic device 200 may further comprise an input/output (I/O) interface 250 between a computer and other input/output devices (for example, a keyboard, a monitor, and the like).

Although FIG. 2 illustrates only one processor 220, the electronic device 200 may comprise a plurality of processors. Any steps described in this disclosure that are executed by the one processor 220 may also be executed jointly or separately by a plurality of processors. For example, if the processor of the electronic device 200 executes Step A and Step B, it should be understood that Step A and Step B may be executed jointly by two different processors or separately by a single processor (e.g., a first processor executes Step A and a second processor executes Step B, the first processor and the second processor jointly execute Step A and Step B).

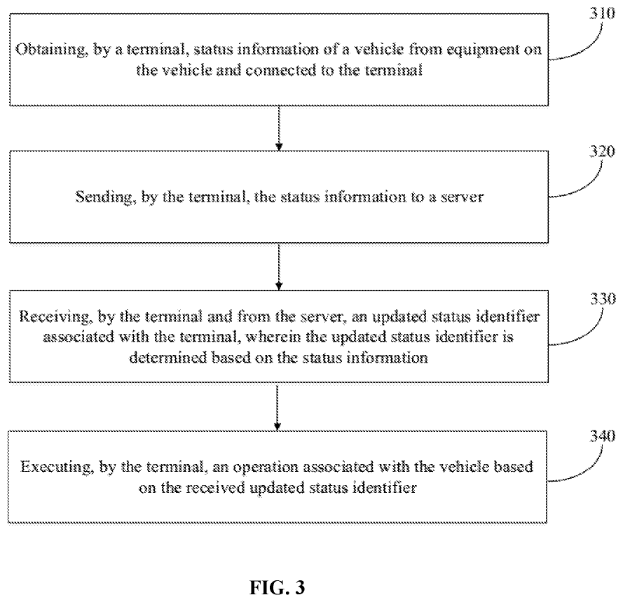

FIG. 3 illustrates an example method for controlling a terminal based on status information of a vehicle. In some embodiments, this method may be executed on a service-providing terminal allowing the terminal to automatically obtain status information of a vehicle recorded by equipment on the vehicle (e.g., onboard equipment) and to synchronize the status information to a server. The server may then determine whether to change a status identifier associated with the service-providing terminal based on the status information and send any updated status identifier back to the service-providing terminal. In this manner, a status identifier associated with the vehicle that is recorded on the service-providing terminal and corresponding to the status information of the vehicle may be automatically recorded and updated, which allows the terminal to execute operations corresponding to the status identifier. Particular embodiments may improve a service provider's order acceptance rate, reduce a service provider's delay in accepting orders online, or reduce a passenger's waiting time after placing an order for transportation services.

The method illustrated in FIG. 3 may begin at step 310, in which a terminal may obtain status information of a vehicle from equipment on the vehicle and connected to the terminal.

In some embodiments, the terminal may be associated with the vehicle or a service provider owning or operating the vehicle. It may be referred to as a service-providing terminal. The service-providing terminal may be any suitable mobile terminal configured to manage, store, and display a status identifier associated with a corresponding vehicle. As an example and not by way of limitation, in the scenario of a ride-hailing service, the service-providing terminal may be a tablet computer configured to manage payment processing for transportation service ordered through a ride-hailing platform, vehicle-returning operations, vehicle-dispatching operations, order-acceptance operations, or other suitable operations. The service-providing terminal may be bound to a particular vehicle. Each vehicle for a particular ride-hailing platform may have a corresponding service-providing terminal.

In some embodiments, the equipment may be installed or mounted on the vehicle (e.g., onboard equipment) and have access to signals and data associated with a status of the vehicle. As an example and not by way of limitation, in the scenario of a ride-hailing service, the equipment may be a taximeter installed on the vehicle. The taximeter may be configured to obtain fares for use of the vehicle and to obtain status information associated with the vehicle as described below.

In some embodiments, the equipment may record status information associated with the vehicle. The status information may be obtained by the equipment based on manual inputs or operations by a user or service provider associated with the vehicle. Alternatively or additionally, the status information may be gathered via data-gathering equipment on the vehicle. In some embodiments, the equipment may obtain, from data-gathering equipment, data that relates to but does not directly indicate a status of the vehicle. The equipment may use pre-set algorithms or logic to determine status information of the vehicle based on the data. Although this disclosure describes obtaining status information of a vehicle in particular manners, this disclosure contemplates obtaining status information of a vehicle in any suitable manner.

In some embodiments, the status information of a vehicle may indicate that the vehicle is in a vacant state, an order-incomplete state, a non-operating state, or another suitable state. In some embodiments, the order-incomplete state may comprise a payment-processing state, a passenger-onboard state, a passenger-pickup state, or another suitable state. In some embodiments, the non-operating state may comprise a state indicating that the vehicle is outside a service area, a state indicating that the vehicle is “resting” (e.g., a driver associated with the vehicle is taking a break), or another suitable state.

At step 320, the terminal may send or synchronize the status information to a server. In some embodiments, the server may be associated with a ride-hailing platform. It may be connected to the terminal via a network connection. The terminal may be associated with a service provider owning or operating the vehicle. The server may process the status information and determine whether to change a status identifier associated with the terminal. If needed, the server may generate an updated status identifier based on the status information.

At step 330, the terminal may receive from the server an updated status identifier associated with the terminal, wherein the updated status identifier is determined based on the status information.

At step 340, the terminal may execute an operation associated with the vehicle based on the received updated status identifier.

Particular embodiments therefore automatically record or synchronize status information obtained from onboard equipment on a vehicle to a server associated with service-providers. The server may determine whether to change a current status identifier associated with a service-providing terminal, allowing the service-providing terminal to execute one or more operations corresponding to the current status identifier. Particular embodiments thereby reduce the cost and time consumption for operating a service-providing terminal and improve the efficiency of executing operations based on vehicle status information.

In some embodiments, the updated status identifier generated by the server and sent to the terminal may comprise a request-accepting status identifier indicating that a new service request received by the terminal can be accepted, a request-rejecting status identifier indicating that a new service request received by the terminal must be rejected, a payment-processing status identifier indicating that a payment for a service order fulfilled by the terminal is to be processed, another suitable identifier, or any combination thereof.

In some embodiments, to execute an operation associated with the vehicle, a service-providing terminal may determine that the updated status identifier is a request-accepting status identifier and accordingly accept a service request associated with the vehicle received by the terminal. Here, the vehicle may be automatically dispatched based on the updated status identifier without manual input from its driver. It reduces the operation cost of the driver. Even if the driver neglects to perform a vehicle-dispatching operation and to accept an order for transportation service, the service-providing terminal may improve the driver's effective online duration by automatically executing the vehicle-dispatching operation. The terminal automatically executing a vehicle-dispatching operation based on an updated status identifier can effectively prevent the situation where a driver forgets to dispatch the vehicle, thus increasing an effective online duration of the driver.

In some embodiments, to execute an operation associated with the vehicle, a service-providing terminal may determine that the updated status identifier is a request-rejecting status identifier and reject a service request associated with the vehicle received by the terminal. Here, the vehicle may be automatically returned to an inactive state based on the updated status identifier without manual input from its driver. It reduces the operation cost of the driver. Even if the driver neglects to perform a vehicle-returning operation, the service providing terminal may reduce the driver's order-rejection rate, increase the efficiency of order distribution, and reduce a distributed order stop-loss rate by automatically performing the vehicle-returning operation. The terminal automatically executing a vehicle-returning operation based on an updated status identifier can prevent the situation where an order is sent to a driver where the driver is unable to accept the order, thus effectively reduce the driver's order-rejection rate and increase an efficiency of order distribution.

In some embodiments, to execute an operation associated with the vehicle, a service providing terminal may determine that the updated status identifier is a payment-processing status identifier. Accordingly, the terminal may enter a payment process. It may obtain a fare for the service order recorded by the equipment on the vehicle and determine a target fare based on the fare recorded by the equipment. The service-providing terminal may send the target fare to a terminal associated with a service requester. After receiving the target fare from the service-providing terminal, the terminal associated with the service requester (e.g., a service-requesting terminal) may initiate a payment based on the target fare and exchange appropriate information with the service-providing terminal to complete the payment process.

In some embodiments, the vehicle status information recorded by the equipment on the vehicle (e.g., onboard equipment) may indicate that the vehicle is in a payment-processing state. The onboard equipment may categorize relevant fares and fill them into different fare items of the service-providing terminal. As an example and not by way of limitation, the total fare may comprise two fare items or two lines of fare. A first line may record an order fare, where the order fare=total fare−freeway fees. A second line may record the freeway fees. The driver may further manually input other relevant expenses for the order into the mobile terminal including, for example, parking fees. In some embodiments, the target fare for an order may be determined by obtaining surcharges of the order and calculating a sum of the surcharges and the order fare to obtain the target fare. The surcharges may be manually input by the driver into the service-providing terminal. The surcharges may comprise freeway fees, parking fees, passenger pickup fees, fees defined by the driver, other suitable charges, or any combination thereof. The surcharges may correspond to the transportation service provided under the order. The surcharges may be manually modified by the driver. The mobile terminal may obtain the surcharges by receiving the driver's input.

In some embodiments, surcharges for an order recorded at a service-providing terminal may further comprise a long-distance discount amount, a disability discount amount, a senior citizen discount amount, a fixed rental fee, a goods loading amount, a morning charging amount, a reservation amount, an electronic toll collection (ETC) deduction amount, a prepayment amount, an ETC discount amount, a passenger-pickup amount, an ETC deduction amount generated as a result of passenger pickup, amount paid by each payment method, amount of a discount card, other suitable surcharges, or any combination thereof. In addition, the onboard equipment may further be used to transfer coupons to the service-providing terminal.

In some embodiments, the payment process based on order fare transmitted by the onboard equipment may save the driver the effort of manually initiating the payment process and reduce the waiting time for payment by the payment-requesting terminal. The fare recorded by the equipment may be sent to not only the service-providing terminal but also the server for service-providing terminals. The transmission of information associated with the fare may be initiated by requests from the service-providing terminal or the server. For example, the service-providing terminal may send a request to the equipment for the fare when it enters the payment process. Both the service-providing terminal and the server may record such fare. The server may determine, based on the received data, the accuracy of the fare calculating by the charging system (implemented on the onboard equipment and service-providing terminal). This may enable determination of a difference between the fare recorded by the onboard equipment and that manually input at the service-providing terminal, in order to facilitate detection of fraudulent billing activities by drivers. This may improve supervision over service providers and the user experience for service requesters.

In some embodiments, automatic vehicle dispatching and returning may be implemented by synchronizing vehicle status information stored on an onboard equipment. In some embodiments, the service-providing terminal may be configured to include buttons corresponding to operations such as vehicle dispatching and vehicle returning or to deactivate such buttons. In some embodiments, when a service provider manually interacts with buttons corresponding to vehicle dispatching or returning in a user interface associated with the service-providing terminal, a notification may be displayed indicating that an onboard equipment is connected and that such manual interactions are unnecessary.

Particular embodiments described above, through synchronization of vehicle status information recorded by an onboard equipment on the vehicle, may implement automatically-executed vehicle returning, vehicle dispatching, payment processing, or other suitable operations. They may thereby reduce the operation cost for a service provider, improves the efficiency of service order distribution. Furthermore, obtaining the fare recorded by the onboard equipment may facilitate evaluation of the accuracy of the charging system.

In some embodiments, in addition to the aforementioned operations, the server may control the service-providing terminal to execute one or more other operations based on status information of the vehicle. As an example and not by way of limitation, in the scenario of a ride-hailing service, the status information synchronized to the server associated with the ride-hailing platform may indicate that the vehicle is in an abnormal operating state. According to such status information, the server may instruct the service-providing terminal to execute operations such as forced engine stalling, reporting a route of the vehicle to a related online platform, reporting a speed of the vehicle to a related online platform, recording images or videos of the inside of the vehicle and uploading the same to related online platform, or other suitable operations. As another example and not by way of limitation, in a private-use scenario for example, the status information synchronized to a server may indicate that the vehicle is in an abnormal region, a mobile terminal associated with the vehicle that may be similar to the service-providing terminal may execute one or more operations such as reporting a location of the vehicle to a related platform, recording images or videos of inside of the vehicle and uploading the same to a related platform, or other suitable operations.

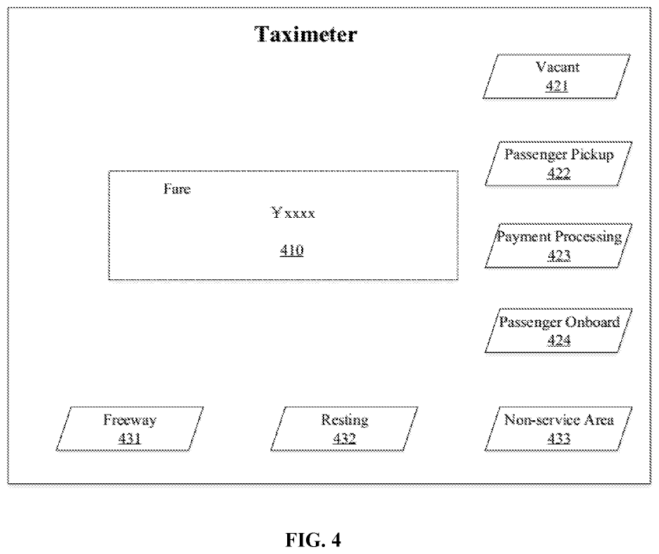

FIG. 4 illustrates an example interface associated with an example taximeter. In some embodiments, the onboard equipment described above may comprise a taximeter (e.g., Yazaki LT27 Meter). The taximeter may comprise a field 410 displaying a recorded fare for transportation services. As illustrated by FIG. 4, the taximeter may indicate a status of the vehicle comprising, for example, passenger pickup 422, payment processing 423, passenger onboard 424, vehicle vacant 421, vehicle outside a service area 433, resting 432, vehicle on a freeway 431, another suitable state, or any combination thereof. A service provider or driver may interact with an interactive element or button on the interface associated with the taximeter to indicate a status of the vehicle. The taximeter may determine such status information based on the user interaction. As an example, if the vehicle is in a state of being vacant 421, the vehicle or service-providing terminal may be allowed to accept new orders requesting transportation service. As another example, if the vehicle is in a state of being outside a service area 433, being resting 432, picking up a passenger 422, processing payment 423, or having a passenger onboard 424, the vehicle or service-providing terminal may not be allowed to accept new orders requesting transportation service.

In some embodiments, after status information of the vehicle is synchronized to the server, the server may determine whether to update a status identifier for the service-providing terminal. The service-providing terminal may execute operations corresponding to the updated status identifier. As an example and not by way of limitation, if the status information synchronized from the service-providing terminal to the server indicates that the vehicle is in a vacant state, the status identifier for the service-providing terminal may be updated to be a request-accepting status and the service-providing terminal may execute a vehicle-dispatching operation based on the updated status identifier. Automatically synchronizing vehicle status information and automatically executing operations corresponding to an updated status identifier may save time cost for executing operations and improve the efficiency of the service-providing terminal in executing certain operations.

In some embodiments, the terminal may have access to a data store associated with the equipment on the vehicle via a network connection. The network connection may comprise a Bluetooth connection, which may or may not be established through a Bluetooth box. The data store may be configured to permit data reading but block data writing by the terminal. In some embodiments, the taximeter illustrated by FIG. 4 may use the ultron operating system. The taximeter may only support data reading but not data writing. This may allow reading data from the taximeter in order to update the status identifier associated with a service-providing terminal, while data writing from the service-providing terminal to the taximeter to change the status of the taximeter is prohibited. Such configuration may improve the accuracy of the vehicle status information recorded by the taximeter, since modification of the data by the service-providing terminal or other terminals is not allowed. Furthermore, the taximeter may record fares associated with use of the vehicle. By prohibiting modifications to the data recorded by the taximeter, particular embodiments effectively improve the accuracy of fare calculation and prevents malicious modification to the fare by service providers.

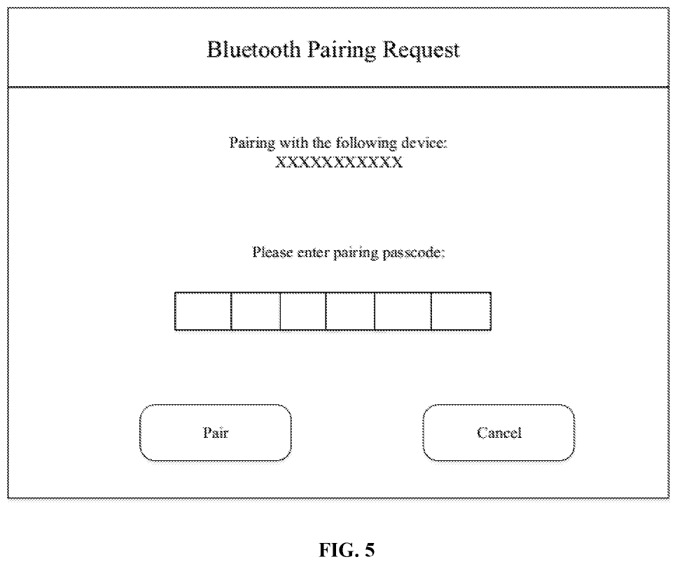

FIG. 5 illustrates an example method for obtaining status information from equipment on a vehicle. In some embodiments, a service-providing terminal may obtain status information of a vehicle recorded by an onboard equipment. The method of FIG. 5 may begin at step 510, where a terminal may determine, based on an identifier associated with the vehicle, that the vehicle is installed with equipment. In some embodiments, the identifier associated with the vehicle may comprise a license plate number of the vehicle, an engine serial number of the vehicle, another suitable identifier, or any combination thereof. Determining whether the vehicle is installed with equipment may be performed by determining whether the license plate number of the vehicle or the engine serial number of the vehicle is bound to identifier corresponding to equipment. The binding or association between the license plate number or engine serial number and the equipment identifier may have been created prior to performance of steps of this method.

At step 520, the terminal may obtain an identifier associated with the equipment. Such an identifier may only be obtained if the vehicle corresponding to the terminal is bound with such equipment. In some embodiments, the identifier may comprise a user name associated with the onboard equipment or a media access control (MAC) address of the onboard equipment. In some embodiments, the MAC address of the onboard equipment may be a MAC address of a Bluetooth component or module associated with the onboard equipment. The terminal may scan for the MAC address of the Bluetooth component.

At step 530, the terminal may establish a network connection with the equipment based at least in part on the obtained identifier associated with the equipment. At step 540, the terminal may obtain the status information from the equipment via the network connection.

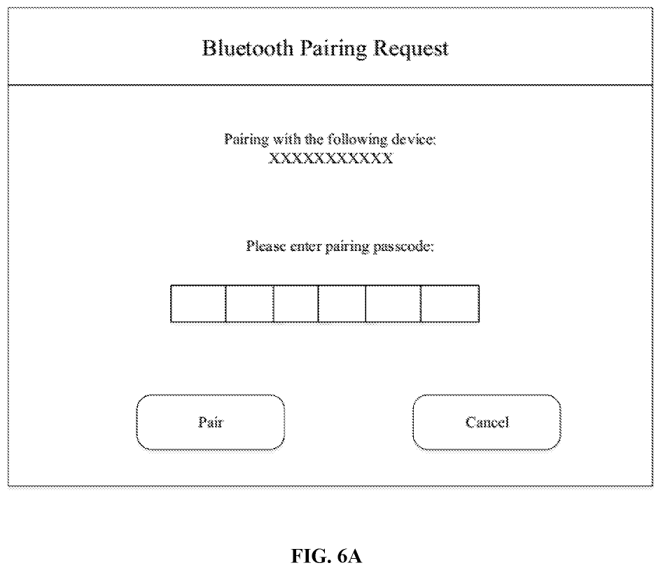

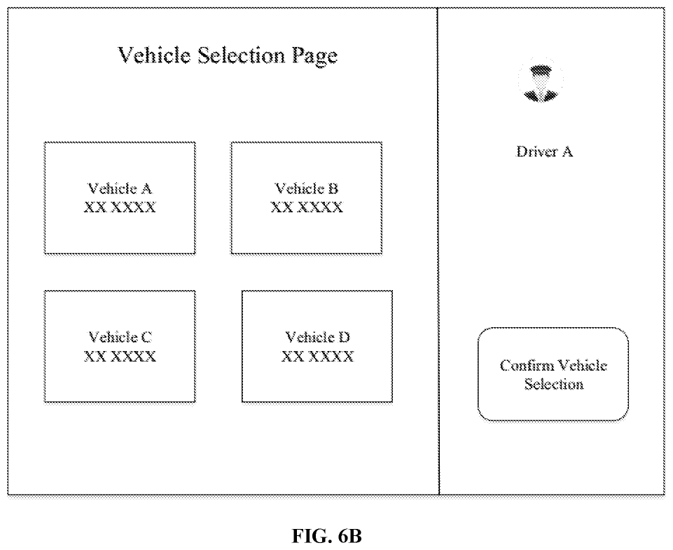

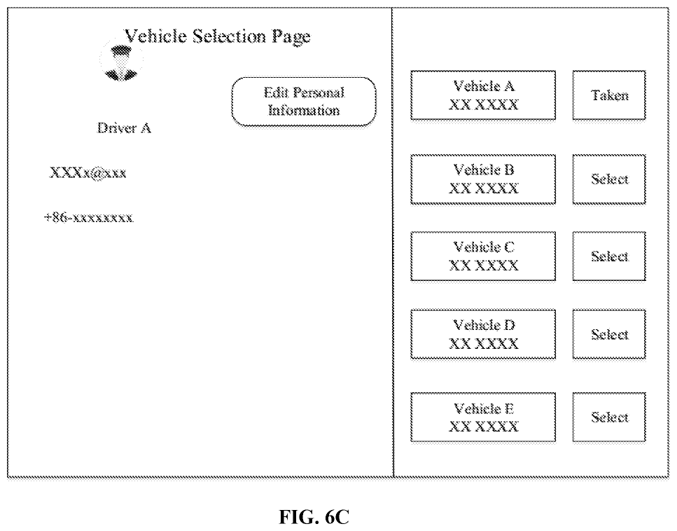

FIG. 6A illustrates an example interface for establishing a connection between a terminal and equipment on a vehicle using a Bluetooth box. At step 530 illustrated in FIG. 5, the terminal may establish a Bluetooth connection with the equipment. In some embodiments, the Bluetooth connection may be established via a Bluetooth box associated with the equipment. Specifically, a service-providing terminal may obtain a user name or UID that is bound with a license plate number or an engine serial number of the vehicle, where the user name or UID corresponds to onboard equipment of the vehicle. Then, the service-providing terminal may establish a network connection with the equipment using the user name and a pairing passcode. Here, a correlation or correspondence relationship between the service-providing terminal and the vehicle may be previously established.

In the absence of a Bluetooth box, the network connection between the service-providing terminal and the onboard equipment may be established using a MAC address of a Bluetooth module or component in the onboard equipment. Specifically, the service-providing terminal may obtain a MAC address that is bound to the license plate number or an engine serial number of the vehicle, where the MAC address corresponds to a Bluetooth component of onboard equipment of the vehicle. The service-providing terminal may then establish a network connection with the onboard equipment based on the obtained MAC address. Here, a correlation or correspondence relationship between the service-providing terminal and the vehicle may be previously established.

In some embodiments, if the Bluetooth box or Bluetooth component associated with the onboard equipment is turned off, the equipment or the service-providing terminal may prompt the user or driver of the vehicle to turn on the Bluetooth box or the Bluetooth communication functionalities of the Bluetooth component of the equipment. In some embodiments, if a particular license plate number or engine serial number does not exist in the process of setting up the bounding relationship between the license plate number or engine serial number with an identifier of an onboard equipment, the service-providing terminal may display a notification indicating that the license plate number or engine serial number does not exist. If the identifier of an onboard equipment bound to a vehicle license plate number or engine serial number is incorrect, the service-providing terminal may display a notification indicating that the identifier of the onboard equipment is inaccurate to allow relevant personnel to perform diagnosis or to re-enter the identifier of the onboard equipment. If an identifier of onboard equipment has been bound to a license plate number or engine serial number, the service-providing terminal may display a notification indicating that the onboard equipment has been bound to allow relevant personnel to determine whether to use a new bounding relationship to replace an existing one.

In some embodiments, after a connection has been established between the onboard equipment and the service-providing terminal, the service-providing terminal may display message “Onboard Equipment Successfully Connected.” A front page of the service-providing terminal may comprise a status notification indicating that the onboard equipment has been connected.

In some embodiments, each time when a service provider is selecting a vehicle, it may be checked whether the selected vehicle is installed with a corresponding onboard equipment. The checking may be performed by checking whether the license plate number or engine serial number of the vehicle is bound with an identifier of onboard equipment. If the vehicle is installed with a corresponding onboard equipment, one or more of the aforementioned steps may be used to pair the service-providing terminal corresponding to the vehicle to the onboard equipment, to establish network connection between the devices.

Whether the vehicle is equipped with the corresponding on-board equipment is automatically detected when the driver chooses the vehicle, that is, whether the license plate or engine number of the vehicle is bound with the identifier of the on-board equipment. If the vehicle is equipped with the corresponding on-board equipment, the corresponding service provider and the corresponding on-board equipment of the vehicle are automatically matched by the above steps to realize the communication between the corresponding service provider and the corresponding on-board equipment of the vehicle.

FIG. 6B illustrates an example interface for selecting a vehicle. In some embodiments, a driver may select one of multiple different vehicles based on their license plate numbers by clicking on interactive elements (e.g., a Confirm Vehicle Selection button) in a user interface illustrated by FIG. 6B. After the driver selects a vehicle, the service-providing terminal may automatically detect whether the selected vehicle has a corresponding onboard equipment. If the selected vehicle has a corresponding onboard equipment, one or more steps described above may be used to automatically pairing the service-providing terminal corresponding to the vehicle with the onboard equipment and establishing a network connection between them.

FIG. 6C illustrates an example interface for selecting a vehicle. In some embodiments, a driver may also configure personal information on an interface for vehicle selection. The personal information that may be set may include the driver's email address, the driver's phone number, other suitable information, or any combination thereof. The interface may further comprise status information showing whether each vehicle has been selected by another driver. The driver may select a vehicle based on such status information, which may improve a success rate for vehicle selection.

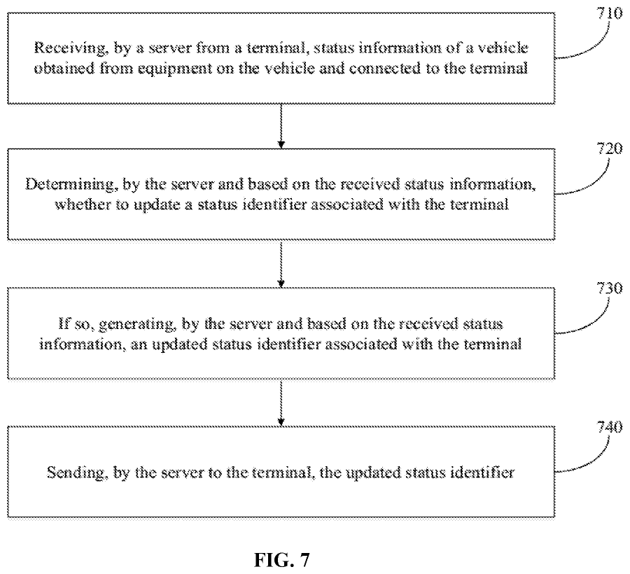

FIG. 7 illustrates an example method for updating a status identifier associated with a terminal based on status information of a vehicle. The method illustrated by FIG. 7 may begin at step 710, where a server may receive, from a terminal, status information of a vehicle obtained from equipment on the vehicle and connected to the terminal. Here, the server may be associated with a ride-hailing platform and the terminal may be a service-providing terminal corresponding to the vehicle. The status information is thereby synchronized to the server.

At step 720, the server may determine, based on the received status information, whether to update a status identifier associated with the terminal. At step 730, if the status identifier needs to be updated, the server may generate, based on the received status information, an updated status identifier associated with the terminal. As an example and not by way of limitation, if the status information indicates that the vehicle is vacant, the server may update the status identifier to be one corresponding to a request-accepting status. As another example and not by way of limitation, if the status information indicates that the vehicle is in an order-incomplete status or a non-operating status, the server may update the status identifier to be one corresponding to a request-rejecting status. In some embodiments, the order-incomplete state may comprise a payment-processing state, a passenger-onboard state, a passenger-pickup state, a state corresponding to the service-providing terminal arriving at location of passenger and waiting for passenger, or another suitable state. In some embodiments, the non-operating state may comprise a state indicating that the vehicle is outside a service area, a state indicating that the vehicle is “resting” (e.g., a driver associated with the vehicle is taking a break), or another suitable state. As yet another example and not by way of limitation, if the status information indicates that the vehicle is in a payment-processing status, the server may update the status identifier to be one corresponding to a payment-processing status. At step 740, the server may send the updated status identifier to the terminal.

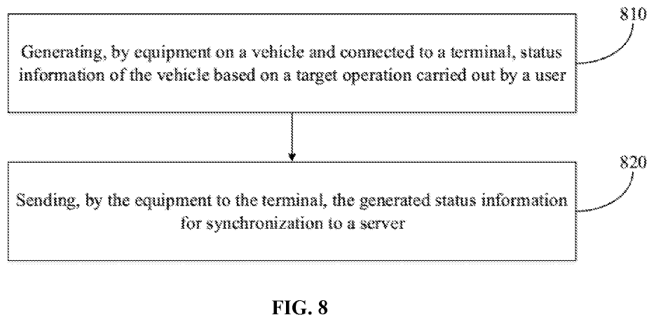

FIG. 8 illustrates an example method for synchronizing status information of a vehicle to a server. The method illustrated by FIG. 8 may begin at step 810, where equipment on a vehicle and connected to a terminal may generate status information of the vehicle based on a target operation carried out by a user. Here, the user may be a service provider or driver of the vehicle. The target operation may comprise a user input on an interface associated with the equipment comprising, for example, clicking, pressing, or tapping a “Vacant” button 421, a “Passenger Onboard” button 424, a “Passenger Pickup” button 422, a “Payment Processing” button 423, another suitable interaction element, or any combination thereof. The status information may comprise, for example, the vehicle being in a vacant state, a passenger-pickup state, a passenger-onboard state, a payment-processing state, an outside-service-area state, a resting state, another suitable status, or any combination thereof.

At step 820, the equipment on the vehicle may send the generated status information to the terminal for synchronization to the server. The status information may be sent to the terminal via a Bluetooth connection between the terminal and the equipment and synchronized to the server via a network connection between the server and the terminal. The server may then determine whether to update the status identifier of the terminal (e.g., a service-providing terminal) based on the status information.

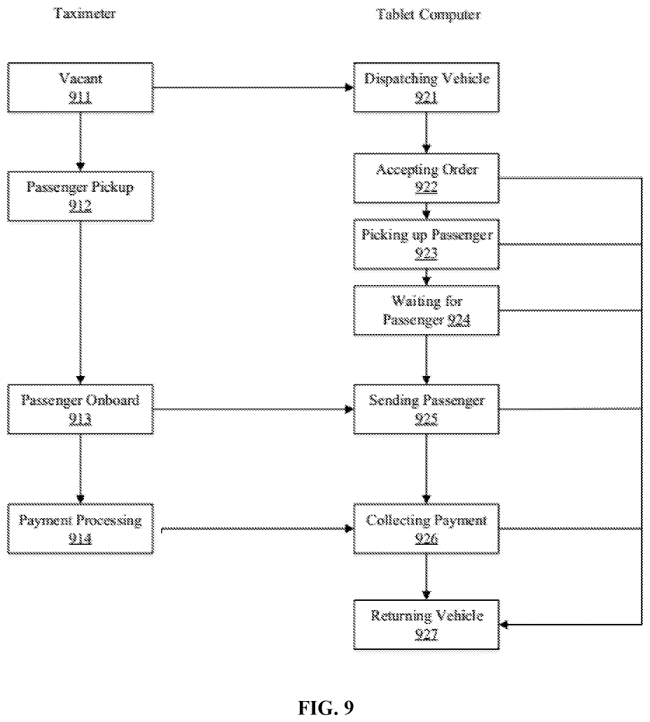

FIG. 9 illustrates an example method for controlling a terminal based on status information of a vehicle. In some embodiments, in the scenario of a ride-hailing service, a terminal or, in particular, a service-providing terminal may be implemented on a tablet computer. Equipment on a vehicle and connected to the terminal may be implemented as a taximeter.

In some embodiments, a driver may click on a “Vacant” button 911 on the taximeter. The taximeter may thereby obtain status information indicating that the vehicle is vacant. Such status information may then be sent from the taximeter to the tablet computer and synchronized from the tablet computer to a server associated with the ride-hailing platform. The server may then update a status identifier associated with the tablet computer to be a request-accepting status. The table computer may execute, based on the updated status identifier, an operation corresponding to dispatching the vehicle.

In some embodiments, a driver may click on a “Passenger Pickup” button 912 on the taximeter. The taximeter may thereby obtain status information indicating that the vehicle is in a passenger-pickup state. Such status information may then be sent from the taximeter to the tablet computer and synchronized from the tablet computer to a server associated with the ride-hailing platform. The server may then update a status identifier associated with the tablet computer to be a request-rejecting status. The tablet computer may execute, based on the updated status identifier, an operation corresponding to returning the vehicle. In some embodiments, the tablet computer may comprise a button 921 corresponding to dispatching the vehicle.

Here, the passenger-pickup state may comprise stages such as accepting the order, picking up the passenger, and waiting for the passenger. The taximeter may or may not include interactive elements corresponding to these stages. In case it does not, it cannot specifically obtain status information corresponding to the stages and send the status information to the terminal. On the other hand, the tablet computer may comprise buttons 922, 923, and 924 corresponding to these stages allowing manual interactions by the driver to perform corresponding updates to the status information.

In some embodiments, a driver may click on a “Passenger Onboard” button 913 on the taximeter. The taximeter may thereby obtain status information indicating that the vehicle is in a passenger-onboard state. Such status information may then be sent from the taximeter to the tablet computer and synchronized from the tablet computer to a server associated with the ride-hailing platform. The server may then update a status identifier associated with the tablet computer to be a request-rejecting status. The tablet computer may execute, based on the updated status identifier, an operation corresponding to returning the vehicle. In some embodiments, the tablet computer may comprise a button 925 corresponding to sending the passenger to the requested destination.

In some embodiments, a driver may click on a “Payment Processing” button 914 on the taximeter. The taximeter may thereby obtain status information indicating that the vehicle is in a payment-processing state. Such status information may then be sent from the taximeter to the tablet computer and synchronized from the tablet computer to a server associated with the ride-hailing platform. The server may then update a status identifier associated with the tablet computer to be a collecting-payment status or an order-payment status. The tablet computer may execute, based on the updated status identifier, an operation corresponding to initiating a payment process and collecting payment from the passenger. In some embodiments, the tablet computer may further comprise buttons 926 and 927, corresponding to collecting payment and returning the vehicle, respectively.

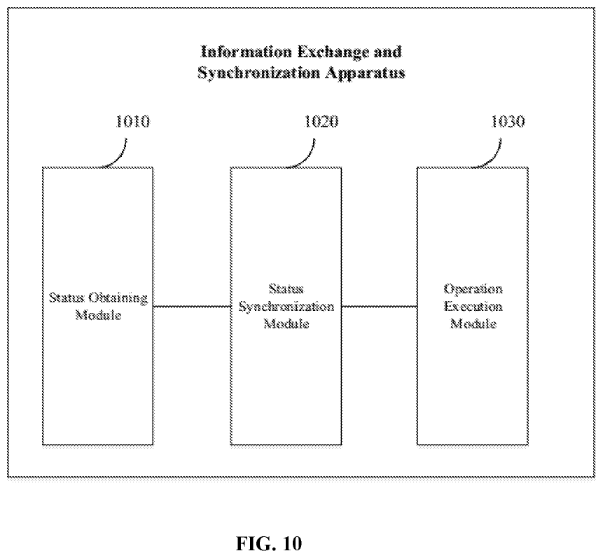

FIG. 10 illustrates a structural diagram of an information exchange and synchronization apparatus. The functionalities of the apparatus may correspond to one or more steps in the methods illustrated in FIGS. 3, 5, 7, and 8. The apparatus may comprise a status obtaining module 1010, configured to obtain status information of a vehicle from equipment on the vehicle and connected to a service-providing terminal. The apparatus may further comprise a status synchronization module 1020, configured to synchronize the obtained status information to a server associated with service-providing terminal, in order to cause the server to determine whether to update a status identifier associated with the service-providing terminal in response to the received vehicle status information.

In some embodiments, the apparatus may further comprise an operation execution module 1030, configured to execute an operation corresponding to the updated status identifier of the service-providing terminal.

In some embodiments, the operation execution module 1030 may be specifically configured to execute an operation to accept a service request when the updated status identifier of the service-providing terminal is a request-accepting status identifier.

In some embodiments, the operation execution module 1030 may be specifically configured to execute an operation to reject a service request when the updated status identifier of the service-providing terminal is a request-rejecting status identifier.

In some embodiments, the operation execution module 1030 may be specifically configured to execute an operation to obtain a fare for a service order recorded by the equipment, determine a target fare, and send the target fare to a terminal associated with a service requester when the updated status identifier of the service-providing terminal is a payment-processing status identifier.

In some embodiments, the operation execution module 1030 may be specifically configured to obtain surcharges of an order and calculate a sum of the surcharges and the fare for the order to obtain the target fare.

In some embodiments, the surcharges may comprise at least one of freeway fees corresponding to the order, parking fees corresponding to the order, and passenger pickup fees corresponding to the order. The obtaining the surcharges may comprise obtaining surcharges entered by the driver.

In some embodiments, the status obtaining module 1010 may be specifically configured to, in case the vehicle is installed with the onboard equipment, obtain an identifier associated with the equipment and obtain, from the onboard equipment corresponding to the identifier and connected to the service-providing terminal, vehicle status information stored in the equipment.

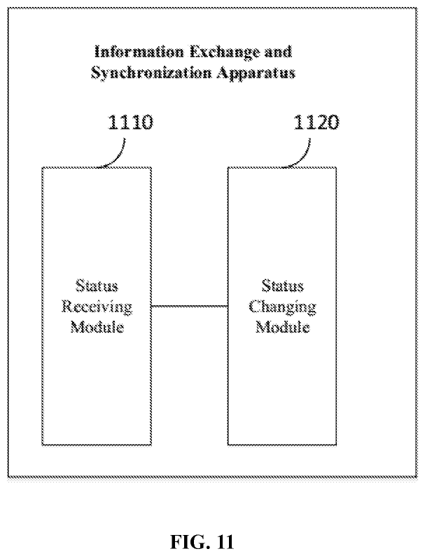

FIG. 11 illustrates a structural diagram of an information exchange and synchronization apparatus. The functionalities of the apparatus may correspond to one or more steps in the methods illustrated in FIGS. 3, 5, 7, and 8. The apparatus may comprise a status receiving module 1110, configured to receive vehicle status information sent by a service-providing terminal and obtained from onboard equipment on a vehicle and connected to the service-providing terminal. The apparatus may further comprise a status changing module 1120, configured to determine whether to change a current status identifier associated with the service-providing terminal based on the received vehicle status information.

In some embodiments, the status changing module 1120 may be specifically configured to, if the received status information indicates that the vehicle is vacant, update the status identifier of the service-providing terminal to be one corresponding to a request-accepting status.

In some embodiments, the status changing module 1120 may be specifically configured to, if the received status information indicates that the vehicle is in an order-incomplete status or a non-operating status, update the status identifier of the service-providing terminal to be one corresponding to a request-rejecting status.

In some embodiments, the order-incomplete state may comprise at least one of a payment-processing state, a passenger-onboard state, and a passenger-pickup state.

In some embodiments, the non-operating state may comprise at least one of a state indicating that the vehicle is outside a service area and a state indicating that the vehicle is resting.

In some embodiments, the status changing module 1120 may be specifically configured to, if the status information indicates that the vehicle is in a payment-processing status, update the status identifier of the service-providing terminal to be one corresponding to a payment-processing status.

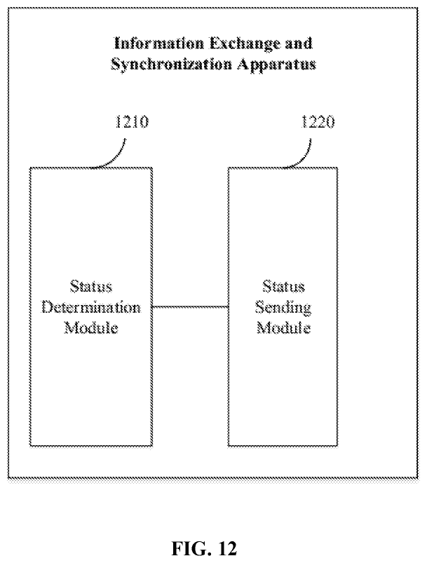

FIG. 12 illustrates a structural diagram of an information exchange and synchronization apparatus. The functionalities of the apparatus may correspond to one or more steps in the methods illustrated in FIGS. 3, 5, 7, and 8. The apparatus may comprise a status determination module 1210, configured to generate vehicle status information to be synchronized to a server associated with service-providing terminals based on a target operation carried out by a user. The apparatus may further comprise a status sending module 1220, configured to send the generated vehicle status information to a service-providing terminal for synchronization to the server, so that the server may then determine whether to change a current status identifier of the service-providing terminal based on the received vehicle status information.

One of ordinary skill in the art can understand details about the operation and processes of the system and apparatus described above by referring to corresponding processes in the method embodiments described above. In some embodiments, the division of the modules may be logical or functional. Alternative methods of division may be used. Multiple modules or components may be combined or integrated into another system. Some features may be omitted or not executed. The mutual coupling, direct coupling, or communication connection that is illustrated or discussed may be replaced by indirect coupling or communication connection through suitable communication interfaces, apparatuses, or modules, which may be electrical, mechanical, or in other suitable forms.

The modules described above as separate components may or may not be physically separated. The components illustrated as modules above may or may not be physical units, i.e., they can be located at one geographic location or distributed over a plurality of network units. The objectives of some embodiments can be achieved by selecting some or all units thereof as needed. The functional units disclosed herein may be integrated into one processing unit or may exist as independent physical units. Two or more units may be integrated into one unit.

In some embodiments, the aforementioned modules may be connected in a wired manner or a wireless manner for mutual connection or communication. The wired connection can comprise metal cables, optical cables, mixed cables, another suitable wired connection, or any combination thereof. The wireless connection can comprise connections in the form of LAN, WAN, Bluetooth, ZigBee, NFC, another suitable wireless connection, or any combination thereof. Two or more modules may be combined into one single module. Any module may be divided into two or more units.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

When the functions disclosed herein are implemented in the form of software functional units and sold or used as independent products, they can be stored in a processor executable non-volatile computer readable storage medium. Particular technical solutions disclosed herein (in whole or in part) or aspects that contributes to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device or a client registered by a user at a platform, wherein the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

The various operations of exemplary methods described herein may be performed, at least partially, by an algorithm. The algorithm may be comprised in program codes or instructions stored in a memory (e.g., a non-transitory computer-readable storage medium described above). Such algorithm may comprise a machine learning algorithm. In some embodiments, a machine learning algorithm may not explicitly program computers to perform a function but can learn from training data to make a predictions model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, the term “or” may be construed in either an inclusive or exclusive sense. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

What is claimed is:

1. A method for controlling a terminal based on status information of a vehicle, comprising:
obtaining, by the terminal, status information of the vehicle from equipment on the vehicle and connected to the terminal;
sending, by the terminal, the status information to a server; and
receiving, by the terminal and from the server, an updated status identifier associated with the terminal, wherein the updated status identifier is determined based on the status information.

2. The method of claim 1, further comprising:
executing, by the terminal, an operation associated with the vehicle based on the received updated status identifier.

3. The method of claim 2, wherein the updated status identifier comprises:
a request-accepting status identifier indicating that a new service request received by the terminal can be accepted;
a request-rejecting status identifier indicating that a new service request received by the terminal must be rejected; or
a payment-processing status identifier indicating that a payment for a service order fulfilled by the terminal is to be processed.

4. The method of claim 3, wherein the executing an operation associated with the vehicle comprises:
determining that the updated status identifier is a request-accepting status identifier; and
accepting a service request associated with the vehicle received by the terminal.

5. The method of claim 3, wherein the executing an operation associated with the vehicle comprises:
determining that the updated status identifier is a request-rejecting status identifier; and
rejecting a service request associated with the vehicle received by the terminal.

6. The method of claim 3, wherein the executing an operation associated with the vehicle comprises:
determining that the updated status identifier is a payment-processing status identifier;
obtaining a fare for the service order recorded by the equipment;
determining a target fare based on the fare recorded by the equipment; and
sending the target fare to a terminal associated with a service requester.

7. The method of claim 1, wherein the obtaining status information of the vehicle comprises:
determining, based on an identifier associated with the vehicle, that the vehicle is installed with the equipment;
obtaining an identifier associated with the equipment;
establishing a network connection with the equipment based at least in part on the obtained identifier associated with the equipment; and
obtaining the status information from the equipment via the network connection.

8. The method of claim 1, wherein:
the terminal has access to a data store associated with the equipment via a network connection; and
the data store is configured to permit data reading but block data writing by the terminal.

9. A system associated with a terminal controlled based on status information of a vehicle, comprising a processor and a non-transitory computer-readable storage medium storing instructions executable by the processor to cause the system to perform operations comprising:
obtaining status information of the vehicle from equipment on the vehicle and connected to the terminal;
sending the status information to a server; and
receiving, from the server, an updated status identifier associated with the terminal, wherein the updated status identifier is determined based on the status information.

10. The system of claim 9, wherein the operations further comprise:
executing an operation associated with the vehicle based on the received updated status identifier.

11. The system of claim 10, wherein the updated status identifier comprises:
a request-accepting status identifier indicating that a new service request received by the terminal can be accepted;
a request-rejecting status identifier indicating that a new service request received by the terminal must be rejected; or
a payment-processing status identifier indicating that a payment for a service order fulfilled by the terminal is to be processed.

12. The system of claim 11, wherein the executing an operation associated with the vehicle comprises:
determining that the updated status identifier is a request-accepting status identifier; and
accepting a service request associated with the vehicle received by the terminal.

13. The system of claim 11, wherein the executing an operation associated with the vehicle comprises:
determining that the updated status identifier is a request-rejecting status identifier; and
rejecting a service request associated with the vehicle received by the terminal.

14. The system of claim 11, wherein the executing an operation associated with the vehicle comprises:
determining that the updated status identifier is a payment-processing status identifier;
obtaining a fare for the service order recorded by the equipment;
determining a target fare based on the fare recorded by the equipment; and
sending the target fare to a terminal associated with a service requester.

15. The system of claim 9, wherein the obtaining status information of the vehicle comprises:
determining, based on an identifier associated with the vehicle, that the vehicle is installed with the equipment;
obtaining an identifier associated with the equipment;
establishing a network connection with the equipment based at least in part on the obtained identifier associated with the equipment; and
obtaining the status information from the equipment via the network connection.

16. The system of claim 9, wherein:
the terminal has access to a data store associated with the equipment via a network connection; and
the data store is configured to permit data reading but block data writing by the terminal.

17. A non-transitory computer-readable storage medium associated with a terminal controlled based on status information of a vehicle, configured with instructions executable by one or more processors to cause the one or more processors to perform operations comprising:
obtaining status information of the vehicle from equipment on the vehicle and connected to the terminal;
sending the status information to a server; and
receiving, from the server, an updated status identifier associated with the terminal, wherein the updated status identifier is determined based on the status information.

18. The medium of claim 17, wherein the operations further comprise:
executing an operation associated with the vehicle based on the received updated status identifier.

19. The medium of claim 18, wherein the updated status identifier comprises:
a request-accepting status identifier indicating that a new service request received by the terminal can be accepted;
a request-rejecting status identifier indicating that a new service request received by the terminal must be rejected; or
a payment-processing status identifier indicating that a payment for a service order fulfilled by the terminal is to be processed.

20. The medium of claim 17, wherein the obtaining status information of the vehicle comprises:
determining, based on an identifier associated with the vehicle, that the vehicle is installed with the equipment;
obtaining an identifier associated with the equipment;
establishing a network connection with the equipment based at least in part on the obtained identifier associated with the equipment; and
obtaining the status information from the equipment via the network connection.
